(19) United States
(12) Patent Application Publication
(10) Pub. No.: US 2025/0391625 A1
(43) Pub. Date: Dec. 25, 2025

(54) OPERATING MECHANISM FOR CIRCUIT BREAKER AND CIRCUIT BREAKER

(71) Applicant: SHANGHAI CHINT LOW VOLTAGE ELECTRICAL TECHNOLOGY CO., LTD., Shanghai (CN)

(72) Inventors: Chaoju JIA, Shanghai (CN); Zhibin QIN, Shanghai (CN); Dasheng XU, Shanghai (CN); Na XIN, Shanghai (CN)

(21) Appl. No.: 18/879,986

(22) PCT Filed: Feb. 7, 2024
(86) PCT No.: PCT/CN2024/076616

§ 371 Date: Dec. 30, 2024

(30) Foreign Application Priority Data
May 15, 2023 (CN) 202310543645.9
May 15, 2023 (CN) 202321162582.4

(51) Int. Cl. H01H 71/04

(52) U.S. Cl. CPC H01H 71/04; H01H 2071/042

(57) ABSTRACT

The operating mechanism for a circuit breaker includes a frame; an energy storage unit, an opening and closing transmission unit and a trip transmission unit; and a closing readiness indicator including an indicator body, where the indicator body is provided with a first linkage portion, a second linkage portion and a third linkage portion. The closing readiness indicator is in a closable display state when the energy storage unit is in an energy storage state, the opening and closing transmission unit is in an opened state, and the trip transmission unit (4) is in a free state. The closing readiness indicator is in a non-closable display state when the energy storage unit is in an energy release state, or the opening and closing transmission unit is in a closed state, or the trip transmission unit is in a non-free state.

This application claims priority to Chinese Patent Application No. 202310543645.9 and Chinese Patent Application No. 202321162582.4 filed with the China National Intellectual Property Administration (CNIPA) on May. 15, 2023, the disclosures of which are incorporated herein by reference in their entireties.

### TECHNICAL FIELD

The application relates to the technical field of low voltage apparatuses, for example, to an operating mechanism for a circuit breaker and a circuit breaker.

### BACKGROUND

As an electrical device that controls electrical transmission lines to turn on and off, a circuit breaker has performances directly affecting the safety of downstream electrical devices. Any circuit breaker fault may cause huge economic losses or even casualties. As an executor of the circuit breaker and the core of the entire circuit breaker, an operating mechanism is responsible for providing the energy required for opening and closing operations of the circuit breaker and performing the opening and closing operations.

The circuit breaker at least includes a pair of contacts and the operating mechanism for closing and opening the pair of contacts. The operating mechanism may be in multiple different states. To display the state of the operating mechanism, the operating mechanism is also provided with a state indication component. Usual state indications of the operating mechanism include closing and opening indications and energy storage and release indications. When the state indication component of the circuit breaker displays that the circuit breaker is in the opening and energy storage states, the circuit breaker is generally considered in a closable state. However, in fact, this is not the case. When a trip core of an undervoltage tripper in the circuit breaker is in a push-out position, a circuit voltage is lower than a voltage range in which a normal closing is allowable, and the circuit breaker still cannot be closed in this case. Thus, the circuit breaker has to satisfy the following three conditions before being closed: 1. The operating mechanism has to store energy. 2. The circuit breaker has to be in a disconnected (that is, open) state. 3. The trip core of the undervoltage tripper has to be in a retracted position.

For enabling operators to accurately determine whether the circuit breaker is in a closeable state to avoid an ineffective closing, the operating mechanism is provided with a closable state indication apparatus for a circuit breaker, but a connection structure between the closable state indication apparatus for a circuit breaker and the operating mechanism is complex, which does not facilitate installation and replacement and increase the maintenance cost.

### SUMMARY

The present application provides an operating mechanism for a circuit breaker and a circuit breaker, facilitating the installation and replacement of a closing readiness indicator, reducing the maintenance cost, and simplifying an installation structure of the closing readiness indicator, so that an operator can accurately determine whether the circuit breaker is in a closable state and thus an ineffective closing is avoided.

The present application provides an operating mechanism for a circuit breaker. The operating mechanism for a circuit breaker includes a frame, an energy storage unit, an opening and closing transmission unit, a trip transmission unit and a closing readiness indicator.

The energy storage unit, the opening and closing transmission unit and the trip transmission unit are disposed within the frame.

The closing readiness indicator is rotatably disposed on an outer side of a side plate of the frame and includes an indicator body, where the indicator body is provided with a first linkage portion capable of being linked with the energy storage unit, a second linkage portion capable of being linked with the opening and closing transmission unit and a third linkage portion capable of being linked with the trip transmission unit.

The closing readiness indicator is in a closable display state in a case where the energy storage unit is in an energy storage state, the opening and closing transmission unit is in an opened state, and the trip transmission unit is in a free state.

The closing readiness indicator is in a non-closable display state in a case where the energy storage unit is in an energy release state, or the opening and closing transmission unit is in a closed state, or the trip transmission unit is in a non-free state.

As an optional technical solution for the preceding operating mechanism for a circuit breaker, the indicator body is provided with a fourth linkage portion, and the outer side of the side plate of the frame is provided with a signal generator.

The fourth linkage portion triggers the signal generator in a case where the closing readiness indicator is in the closable display state.

The fourth linkage portion is unable to trigger the signal generator in a case where the closing readiness indicator is in the non-closable display state.

As an optional technical solution for the preceding operating mechanism for a circuit breaker, the indicator body is provided with a closing readiness indication portion.

The closing readiness indication portion displays that a closing is ready in a case where the closing readiness indicator is in the closable display state.

The closing readiness indication portion displays that the closing is not ready in a case where the closing readiness indicator is in the non-closable display state.

As an optional technical solution for the preceding operating mechanism for a circuit breaker, the first linkage portion includes a first protruding block protruding from a side surface of the indicator body facing the side plate, and the side plate of the frame is formed with a first slide groove, where the first protruding block passes through the first slide groove and is linked with the energy storage unit, and the first protruding block is slidable along the first slide groove.

As an optional technical solution for the preceding operating mechanism for a circuit breaker, the energy storage unit includes a first cam sheet rotatably connected to the frame and provided with a circumferential portion and a groove portion.

In a case where the energy storage unit is in the energy storage state, the first protruding block is located at a first end of the first slide groove and disposed opposite to the groove portion, or the first protruding block is located at a second end of the first slide groove and disposed within the groove portion. In a case where the energy storage unit is in the energy release state, the first protruding block is located at the first end of the first slide groove and abuts against the circumferential portion.

As an optional technical solution for the preceding operating mechanism for a circuit breaker, the second linkage portion includes a second protruding block protruding from a side surface of the indicator body facing the side plate, and the side plate of the frame is formed with a second slide groove, where the second protruding block passes through the second slide groove and is linked with the opening and closing transmission unit, and the second protruding block is slidable along the second slide groove.

As an optional technical solution for the preceding operating mechanism for a circuit breaker, the opening and closing transmission unit includes an opening and closing indicator and a main shaft that are rotatably connected to the frame separately, where the opening and closing indicator includes a first linkage plate, and the main shaft is provided with a main shaft cantilever.

In a case where the opening and closing transmission unit is in the closed state, the main shaft cantilever presses against a first side of the first linkage plate, a second side of the first linkage plate presses against the second protruding block, and the second protruding block is disposed at a first end of the second slide groove.

In a case where the opening and closing transmission unit is in the opened state, the main shaft cantilever is detached from the first side of the first linkage plate, and the second protruding block is disposed at the first end of the second slide groove or a second end of the second slide groove.

As an optional technical solution for the preceding operating mechanism for a circuit breaker, the third linkage portion includes a third protruding block disposed at one end of the indicator body away from a fourth linkage portion, the side plate of the frame is formed with a third slide groove, and one end of the trip transmission unit passes through the third slide groove and is linked with the third protruding block, where the end of the trip transmission unit linked with the third protruding block is slidable along the third slide groove.

As an optional technical solution for the preceding operating mechanism for a circuit breaker, the trip transmission unit includes an opening half shaft, where the opening half shaft is provided with a linkage shaft passing through the third slide groove.

The linkage shaft is disposed at a first end of the third slide groove in a case where the trip transmission unit is in the free state.

The linkage shaft is disposed at a second end of the third slide groove and presses against the third protruding block in a case where the trip transmission unit is in the non-free state.

As an optional technical solution for the preceding operating mechanism for a circuit breaker, the closing readiness indicator further includes a first resilient member connected to the indicator body and the frame, where the first resilient member is configured to keep the closing readiness indicator in the closable display state in the case where the energy storage unit is in the energy storage state, the opening and closing transmission unit is in the opened state, and the trip transmission unit is in the free state.

The present application further provides a circuit breaker including a circuit breaker body and the operating mechanism for the circuit breaker of any one of the preceding, where the operating mechanism for the circuit breaker is disposed on the circuit breaker body.

### BRIEF DESCRIPTION OF DRAWINGS

FIG. 1 is a partial structural view of a circuit breaker according to an embodiment of the present application.

FIG. 2 is a partial structural view of an operating mechanism according to an embodiment of the present application.

FIG. 3 is a view taken at the first angle to illustrate the structure of a closing readiness indicator according to an embodiment of the present application.

FIG. 4 is a view taken at the second angle to illustrate the structure of a closing readiness indicator according to an embodiment of the present application.

FIG. 5 is a view illustrating the structure of a shield according to an embodiment of the present application.

FIG. 6 is a view taken at the first angle to illustrate the positional structure of a closing readiness indicator when an energy storage unit is in an energy release state according to an embodiment of the present application.

FIG. 7 is a view taken at the second angle to illustrate the positional structure of a closing readiness indicator when an energy storage unit is in an energy release state according to an embodiment of the present application.

FIG. 8 is a partial structural view of an energy storage unit according to an embodiment of the present application.

FIG. 9 is a view taken at the first angle to illustrate the positional structure of a closing readiness indicator when a circuit breaker is in a closed state according to an embodiment of the present application.

FIG. 10 is a view taken at the second angle to illustrate the positional structure of a closing readiness indicator when a circuit breaker is in a closed state according to an embodiment of the present application.

FIG. 11 is a view illustrating the structure of a main shaft according to an example of the present application.

FIG. 12 is a view illustrating the structure of an opening and closing indicator according to an embodiment of the present application.

FIG. 13 is a view taken at the first angle to illustrate the positional structure of a closing readiness indicator when a trip transmission unit is in a non-free state according to an embodiment of the present application.

FIG. 14 is a view taken at the second angle to illustrate the positional structure of a closing readiness indicator when a trip transmission unit is in a non-free state according to an embodiment of the present application.

FIG. 15 is a view illustrating the structure of an opening half shaft according to an embodiment of the present application.

FIG. 16 is a view illustrating the structure of an undervoltage tripper according to an embodiment of the present application.

FIG. 17 is a view taken at the first angle to illustrate the structure of a closing readiness indicator in a closable display state according to an embodiment of the present application.

FIG. 18 is a view taken at the second angle to illustrate the structure of a closing readiness indicator in a closable display state according to an embodiment of the present application.

### REFERENCE LIST

1 frame
11 side plate
111 first slide groove
112 second slide groove
113 third slide groove
12 second installation portion
13 limiting shaft
2 energy storage unit
21 first cam sheet
211 circumferential portion
212 groove portion
22 camshaft
23 second cam sheet
24 energy storage display indicator
3 opening and closing transmission unit
31 opening and closing indicator
311 first linkage plate
312 opening and closing display portion
32 main shaft
321 main shaft cantilever
33 second resilient member
4 trip transmission unit
41 opening half shaft
42 linkage shaft
43 opening cantilever
5 closing readiness indicator
51 indicator body
52 first linkage portion
53 second linkage portion
54 third linkage portion
55 fourth linkage portion
56 closing readiness indication portion
57 first resilient member
58 first installation portion
59 limiting block
510 limiting slide groove
511 indication connecting rod
6 signal generator
7 shield
71 viewing window
100 circuit breaker body
200 undervoltage tripper
201 trip core
301 first direction
302 second direction
303 third direction
304 fourth direction

### DETAILED DESCRIPTION

Technical solutions of embodiments of the present application are described below in conjunction with the drawings. The embodiments described below are merely part, not all of the embodiments of the present application.

In the description of the present application, terms “joined”, “connected” and “fixed” are to be understood in a broad sense unless otherwise expressly specified and limited. For example, the term “connected” may refer to “fixedly connected”, “detachably connected”, or “integrated”, may refer to “mechanically connected” or “electrically connected”, or may refer to “connected directly”, “connected indirectly through an intermediary”, or “connected inside two elements” or “an interaction relation between two elements”. For those of ordinary skill in the art, specific meanings of the preceding terms in the present application may be understood based on specific situations.

In the present application, unless otherwise specified and limited, when a first feature is described as being “on” or “below” a second feature, the first feature and the second feature may be in direct contact or be in contact via another feature between the two features instead of being in direct contact. Moreover, when the first feature is described as being “on”, “above” or “over” the second feature, the first feature is right on, above or over the second feature, the first feature is obliquely on, above or over the second feature, or the first feature is simply at a higher level than the second feature. When the first feature is described as being “under”, “below” or “underneath” the second feature, the first feature is right under, below or underneath the second feature, the first feature is obliquely under, below or underneath the second feature, or the first feature is simply at a lower level than the second feature.

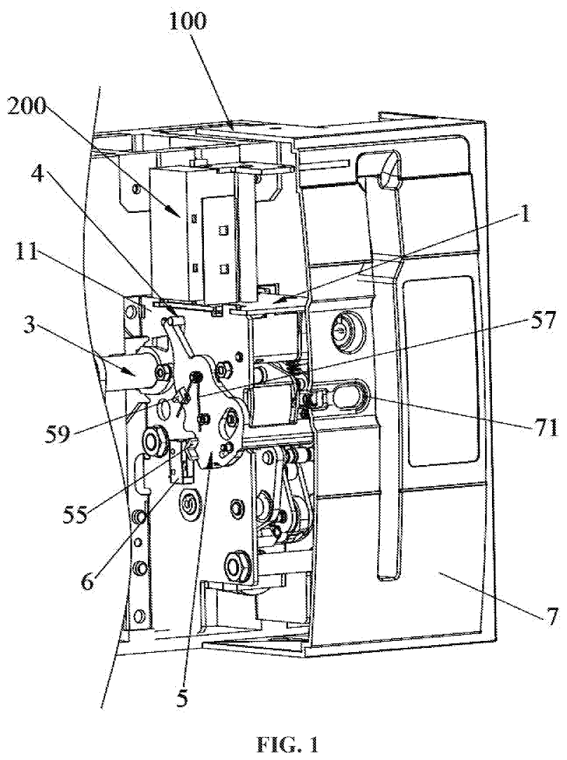

As shown in FIGS. 1 to 3, this embodiment provides an operating mechanism for a circuit breaker. The operating mechanism for a circuit breaker includes a frame 1 and an energy storage unit 2, an opening and closing transmission unit 3 and a trip transmission unit 4. The energy storage unit 2, the opening and closing transmission unit 3 and the trip transmission unit 4 are disposed within the frame 1. The outer side of a side plate 11 of the frame 1 is rotatably provided with a closing readiness indicator 5 to conveniently install and replace the closing readiness indicator 5, reducing the maintenance cost. Moreover, the closing readiness indicator 5 can also be selectively installed so that the circuit breaker can have function selection performance, satisfying the diversifying requirements of the circuit breaker. The closing readiness indicator 5 includes an indicator body 51. The indicator body 51 is provided with a first linkage portion 52 capable of being linked with the energy storage unit 2, a second linkage portion 53 capable of being linked with the opening and closing transmission unit 3 and a third linkage portion 54 capable of being linked with the trip transmission unit 4, simplifying the structure connecting the closing readiness indicator 5 to the energy storage unit 2, the opening and closing transmission unit 3 and the trip transmission unit 4.

The closing readiness indicator 5 is kept in a closable display state when the energy storage unit 2 is in an energy storage state, the opening and closing transmission unit 3 is in an opened state, and the trip transmission unit 4 is in a free state. The closing readiness indicator 5 is kept in a non-closable display state when the energy storage unit 2 is in an energy release state, or the opening and closing transmission unit 3 is in a closed state, or the trip transmission unit 4 is in a non-free state. The states of the energy storage unit 2, the opening and closing transmission unit 3 and the trip transmission unit 4 can keep the closing readiness indicator 5 in the closable display state or the non-closable display state to provide convenience for an operator to accurately determine whether the circuit breaker is in the closable state so that an ineffective closing is avoided.

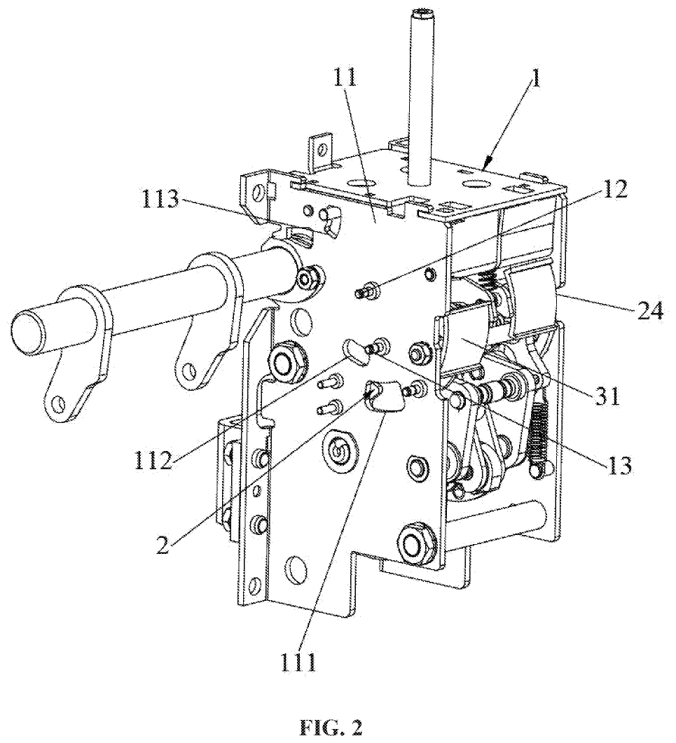

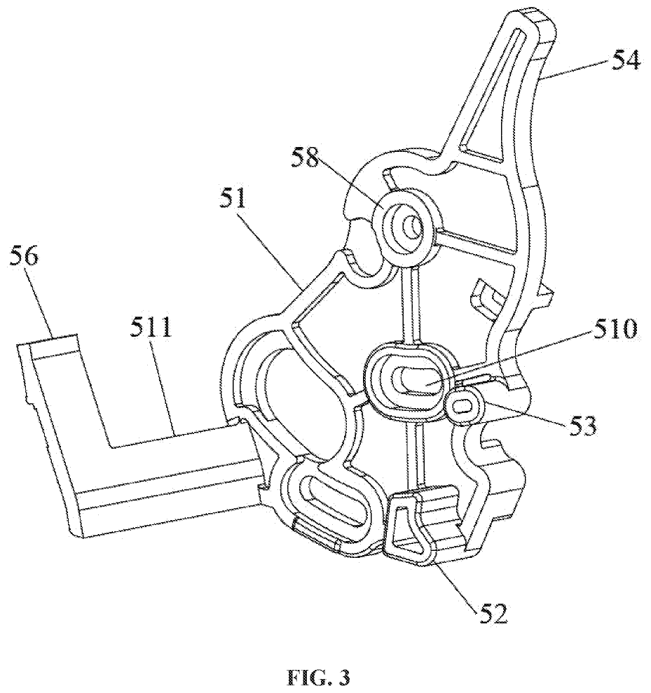

Referring to FIGS. 2 and 3, the indicator body 51 is rotatably connected to the side plate 11 of the frame 1. Exemplarily, the indicator body 51 is provided with a first installation portion 58, the side plate 11 of the frame 1 is provided with a second installation portion 12, and the first installation portion 58 is rotatably connected to the second installation portion 12, thereby rotatably connecting the closing readiness indicator 5 to the frame 1. Optionally, the first installation portion 58 includes an installation hole passing through the indicator body 51, the second installation portion 12 includes an installation shaft perpendicularly connected to the side plate 11 of the frame 1, the installation shaft is inserted into the installation hole, and the closing readiness indicator 5 can rotate around the installation shaft.

In some embodiments, in conjunction with FIGS. 1 to 3, the closing readiness indicator 5 further includes a first resilient member 57 connected to the indicator body 51 and the frame 1. The first resilient member 57 is configured to keep the closing readiness indicator 5 in the closable display state when the energy storage unit 2 is in the energy storage state, the opening and closing transmission unit 3 is in the opened state, and the trip transmission unit 4 is in the free state.

Optionally, the first resilient member 57 is a torsion spring sleeved at one end of the preceding installation shaft away from the frame 1. The torsion spring can limit the displacement of the indicator body 51 in the axial direction of the installation shaft. A first end of the torsion spring is connected to the indicator body 51, and a second end of the torsion spring is connected to the frame 1. The torsion spring provides a force for the closing readiness indicator 5 to be in the closable display state.

To fix the two ends of the torsion spring, the indicator body 51 is provided with a limiting block 59 formed with an accommodation groove, and the first end of the torsion spring is limited within the accommodation groove. The side plate 11 of the frame 1 is provided with a limiting shaft 13. One end of the limiting shaft 13 away from the side plate 11 passes through the indicator body 51 and is disposed on one side of the indicator body 51 facing away from the frame 1. One end of the limiting shaft 13 away from the side plate 11 is formed with a limiting groove, and the second end of the torsion spring is limited within the limiting groove. In order not to affect the rotation of the closing readiness indicator 5, the indicator body 51 is formed with a limiting slide groove 510, the end of the limiting shaft 13 away from the side plate 11 slidably passes through the limiting slide groove 510, and the limiting shaft 13 does not limit the rotation of the closing readiness indicator 5.

In some embodiments, the indicator body 51 is provided with a fourth linkage portion 55, and the outer side of the side plate 11 of the frame 1 is provided with a signal generator 6. When the closing readiness indicator 5 is in the closable display state, the fourth linkage portion 55 triggers the signal generator 6, and the signal generator 6 outputs a closing readiness signal. This reminder signal is an electrical signal, which can provide convenience for the operator to accurately determine whether the circuit breaker is in the closable state so that the ineffective closing is avoided. When the closing readiness indicator 5 is in the non-closable display state, the fourth linkage portion 55 cannot trigger the signal generator 6, so the signal generator 6 cannot output the closing readiness signal to inform the operator that the circuit breaker cannot be closed in this case.

The signal generator 6 may be disposed on the outer side of the side plate 11 of the frame 1. The signal generator 6 may be selectively installed so that the circuit breaker can have the function selection performance, satisfying the diversifying requirements of the circuit breaker.

The fourth linkage portion 55 includes a trigger protruding block disposed on the side of the indicator body 51 facing away from the frame 1, the signal generator 6 is a micro switch, and the trigger protruding block is able to contact a trigger portion of the micro switch to trigger the micro switch to output an electrical signal.

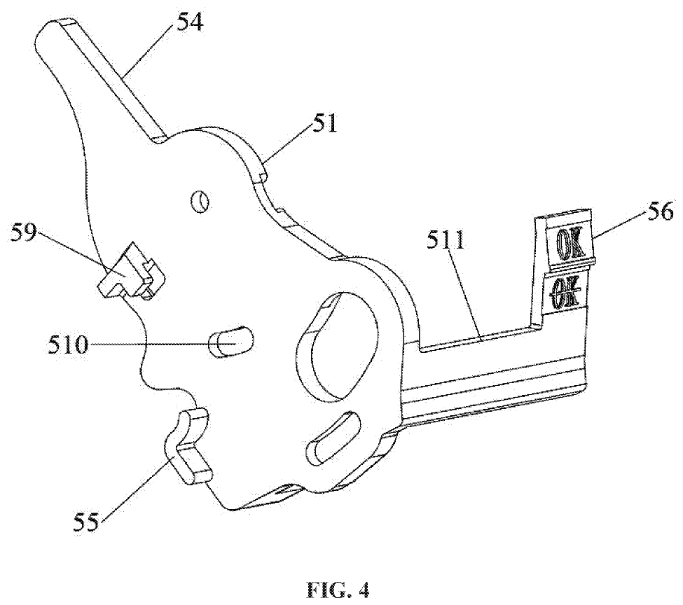

In some other embodiments, as shown in FIG. 4, the indicator body 51 is provided with a closing readiness indication portion 56. When the closing readiness indicator 5 is in the closable display state, the closing readiness indication portion 56 displays that a closing is ready. This display signal is a mechanical signal, and the operator may directly check whether the circuit breaker can be closed, which is intuitive and clear. When the closing readiness indicator 5 is in the non-closable display state, the closing readiness indication portion 56 displays that the closing is not ready to inform the operator that the circuit breaker cannot be closed in this case.

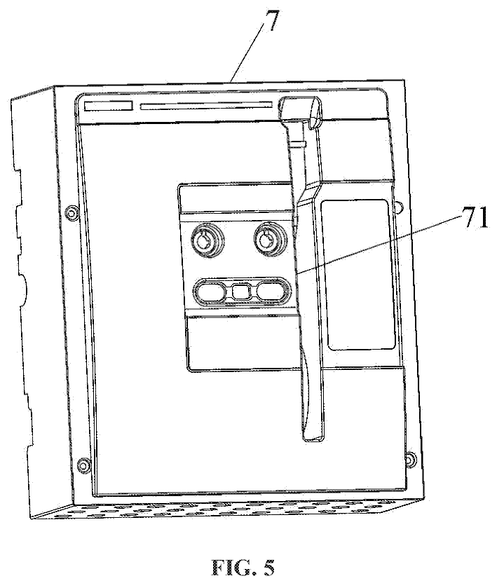

Optionally, the indicator body 51 is connected to an indication connecting rod 511. A first end of the indication connecting rod 511 is connected to the indicator body 51, and a second end of the indication connecting rod 511 is provided with the closing readiness indication portion 56. When the closing readiness indicator 5 is installed on the outer side of the side plate 11 of the frame 1, the end of the indication connecting rod 511 provided with the closing readiness indication portion 56 extends toward the inner side of the frame 1. The outer side of the operating mechanism for a circuit breaker is provided with a shield 7. A position of the shield 7 corresponding to the closing readiness indication portion 56 is provided with a viewing window 71. The operator may observe the current state of the circuit breaker through the viewing window 71 (the shield 7 and the viewing window 71 are shown in FIG. 5).

With continued reference to FIG. 4, the closing readiness indication portion 56 may display “OK” and “OK”. “OK” is disposed above “OK”. The closing readiness indication portion 56 moves up and down to switch “OK” and “OK”. “OK” indicates that the circuit breaker is in the closable state or a state in which the closing is ready. “OK” indicates that the circuit breaker is in the non-closable state or a state in which the closing is not ready.

The closing readiness indication portion 56 may also display words such as “closable” and “non-closable” to inform the operator of the current state of the circuit breaker.

The closing readiness signal may be output in a manner of the preceding electrical signal, a manner of the preceding mechanical signal, or a combination of the two manners to more accurately output the closing readiness signal.

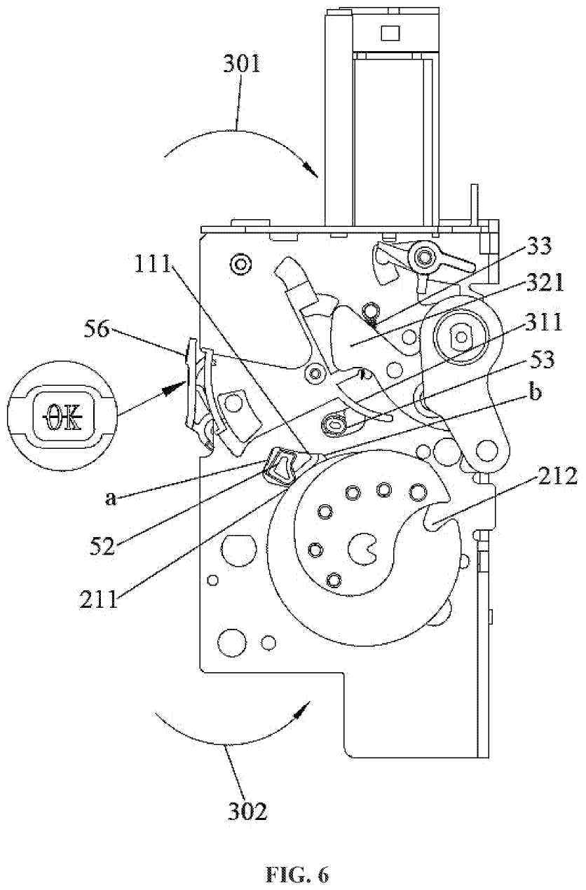

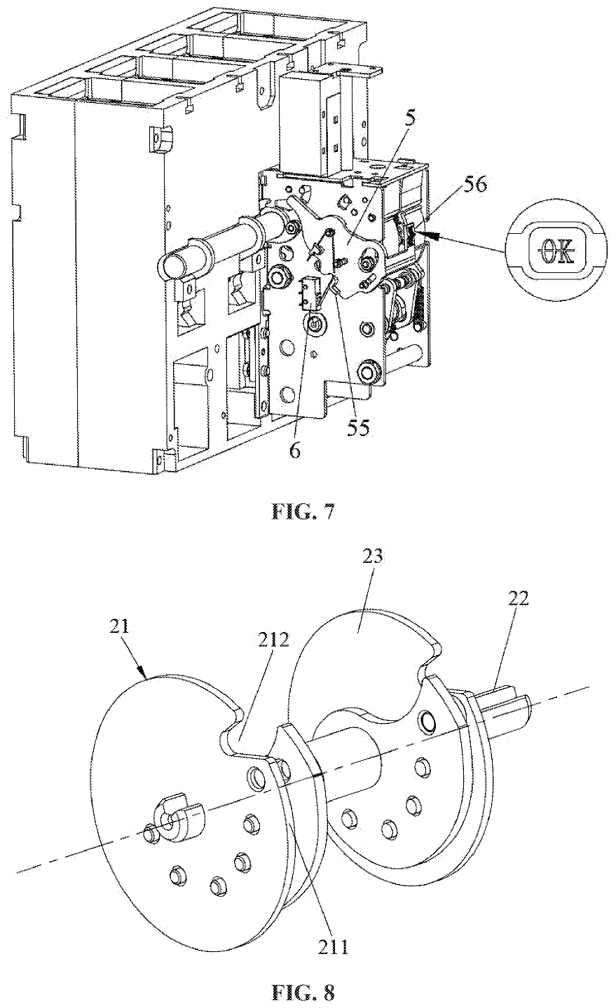

As shown in FIGS. 3 and 6 to 8, the first linkage portion 52 can be linked with the energy storage unit 2. In some embodiments, the first linkage portion 52 includes a first protruding block protruding from the side surface of the indicator body 51 facing the side plate 11, the side plate 11 of the frame 1 is formed with a first slide groove 111, the first protruding block passes through the first slide groove 111 and is linked with the energy storage unit 2 disposed within the frame 1, and the first protruding block can slide along the first slide groove 111 so that the closing readiness indicator 5 can rotate. By disposing the first protruding block on the indicator body 51 to be linked with the energy storage unit 2, the structure is simple, and the indicator body 51 can be directly connected to the energy storage unit 2 through the first protruding block so that the state of the closing readiness indicator 5 can be controlled accurately and precisely.

Optionally, the energy storage unit 2 includes a first cam sheet 21 rotatably connected to the frame 1. Exemplarily, the first cam sheet 21 is disposed on a camshaft 22 rotatably connected to the frame 1, and the first cam sheet 21 can rotate with the camshaft 22.

The first cam sheet 21 is provided with a circumferential portion 211 and a groove portion 212. When the energy storage unit 2 is in the energy storage state, the first protruding block is located at a first end a of the first slide groove 111 and disposed opposite to the groove portion 212, or the first protruding block is located at a second end b of the first slide groove 111 and disposed within the groove portion 212. If the closing readiness indicator 5 is in the closable display state, the first protruding block is located at the second end b of the first slide groove 111 and disposed within the groove portion 212. If the closing readiness indicator 5 is in the non-closable display state, the first protruding block is located at the first end a of the first slide groove 111 and detached from the groove portion 212.

When the energy storage unit 2 is in the energy storage state, the closing readiness indicator 5 rotates around the first direction 301, the first protruding block located at the second end b of the first slide groove 111 is detached from the groove portion 212 and slides to the first end a of the first slide groove 111, the preceding fourth linkage portion 55 does not trigger the signal generator 6, and/or the closing readiness indication portion 56 displays that the closing is not ready. The closing readiness indicator 5 rotates around the second direction 302 opposite to the first direction 301, the first protruding block located at the first end a of the first slide groove 111 slides to the second end b of the first slide groove 111 and into the groove portion 212, the fourth linkage portion 55 triggers the signal generator 6, and/or the closing readiness indication portion 56 displays that the closing is ready.

When the energy storage unit 2 is in the energy release state, the first protruding block is located at the first end a of the first slide groove 111 and abuts against the circumferential portion 211. Exemplarily, when the energy storage unit 2 releases the energy, the first cam sheet 21 rotates around the first direction 301 so that the first protruding block can be detached from the groove portion 212 gradually: with the rotation of the first cam sheet 21, the circumferential portion 211 contacts the first protruding block and pushes the first protruding block to slide from the second end b of the first slide groove 111 to the first end a of the first slide groove 111: the closing readiness indication portion 56 rotates around the first direction 301, the fourth linkage portion 55 does not trigger the signal generator 6, and/or the closing readiness indication portion 56 displays that the closing is not ready.

The energy storage unit 2 further includes a second cam sheet 23 and an energy storage display indicator 24. The second cam sheet 23 and the first cam sheet 21 are parallel and spaced apart on the camshaft 22. The second cam sheet 23 cooperates with the energy storage display indicator 24 to enable the energy storage display indicator 24 to display that the energy storage unit 2 is in the energy storage state or the energy release state.

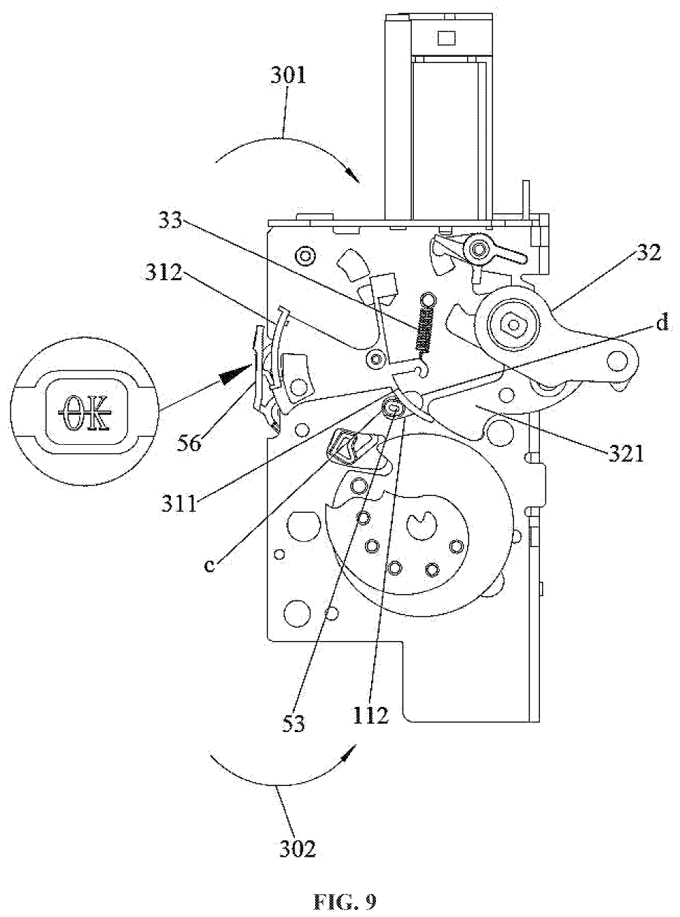

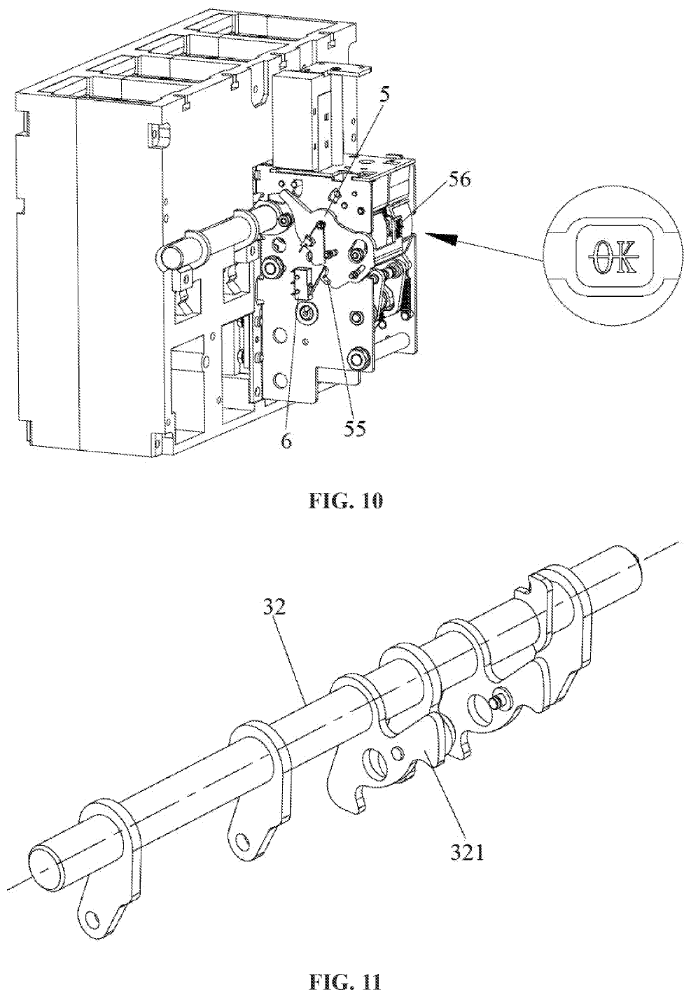

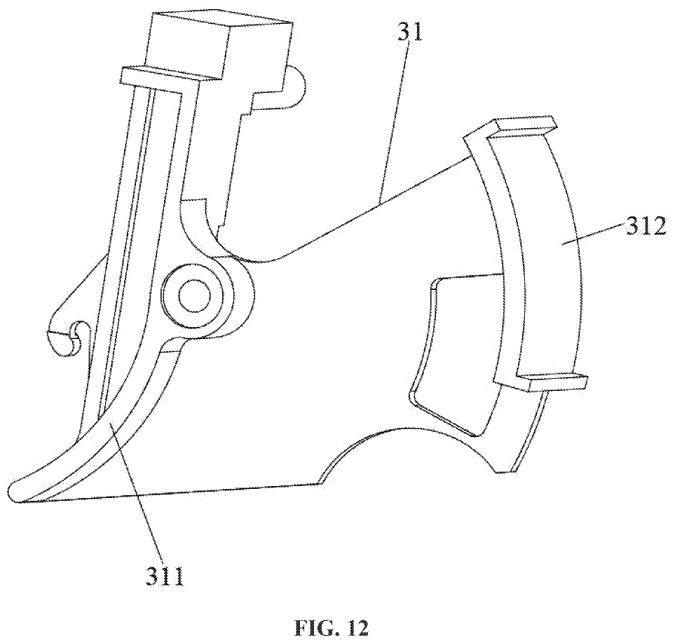

As shown in FIGS. 3 and 9 to 12, the second linkage portion 53 is linked with the opening and closing transmission unit 3. In some embodiments, the second linkage portion 53 includes a second protruding block protruding from the side surface of the indicator body 51 facing the side plate 11, the side plate 11 of the frame 1 is formed with a second slide groove 112, the second protruding block passes through the second slide groove 112 and can be linked with the opening and closing transmission unit 3, and the second protruding block can slide along the second slide groove 112 so that the closing readiness indicator 5 can rotate. By disposing the second protruding block on the indicator body 51 to be linked with the opening and closing transmission unit 3, the structure is simple, and the indicator body 51 can be directly connected to the opening and closing transmission unit 3 through the second protruding block so that the state of the closing readiness indicator 5 can be controlled accurately and precisely.

Optionally, the opening and closing transmission unit 3 includes an opening and closing indicator 31 and a main shaft 32 that are rotatably connected to the frame 1 separately, the opening and closing indicator 31 includes a first linkage plate 311, and the main shaft 32 is provided with a main shaft cantilever 321.

When the opening and closing transmission unit 3 is in the closed state, the main shaft cantilever 321 presses against a first side of the first linkage plate 311, a second side of the first linkage plate 311 presses against the second protruding block, and the second protruding block is disposed at a first end c of the second slide groove 112. Exemplarily, during the closing process of the circuit breaker, the main shaft 32 rotates around the second direction 302, thereby driving the main shaft cantilever 321 to rotate around the second direction 302 and enabling the main shaft cantilever 321 to press against the first side of the first linkage plate 311, and with the rotation of the main shaft cantilever 321, the first linkage plate 311 rotates around the first direction 301 and pushes the second protruding block to slide from a second end d of the second slide groove 112 to the first end c of the second slide groove 112, thereby driving the closing readiness indicator 5 to rotate and be in the non-closable display state. The opening and closing indicator 31 further includes an opening and closing display portion 312. In this case, the opening and closing display portion 312 displays “closing” to indicate that the circuit breaker is in the closed state.

When the opening and closing transmission unit 3 is in the opened state, the main shaft cantilever 321 is detached from the first side of the first linkage plate 311, and the second protruding block is disposed at the first end c of the second slide groove 112 or the second end d of the second slide groove 112. Exemplarily, during the opening process of the circuit breaker, the main shaft 32 rotates around the first direction 301, thereby driving the main shaft cantilever 321 to rotate around the first direction 301, the main shaft cantilever 321 gradually no longer applies pressure to the first linkage plate 311 and is detached from the first linkage plate 311, the first linkage plate 311 rotates around the second direction 302, and the opening and closing display portion 312 displays “opening” to indicate that the circuit breaker is in the opened state. If the energy storage unit 2 is in the energy storage state, and the trip transmission unit 4 is in the free state, the second protruding block slides from the first end c of the second slide groove 112 to the second end d of the second slide groove 112, the second protruding block may abut against the second side of the first linkage plate 311, and the closing readiness indicator 5 rotates and is in the closable display state. If the energy storage unit 2 is in the energy release state, or the trip transmission unit 4 is in the non-free state, the second protruding block is disposed at the first end c of the second slide groove 112, and the closing readiness indicator 5 does not rotate and is in the non-closable display state.

The preceding opening and closing indicator 31 is connected to a second resilient member 33. During the closing process of the circuit breaker and the rotation process of the opening and closing indicator 31 around the first direction 301, the second resilient member 33 stores energy. During the opening process of the circuit breaker, after the main shaft cantilever 321 is detached from the first linkage plate 311, the second resilient member 33 releases the energy so that the opening and closing indicator 31 can rotate around the second direction 302 to achieve that the opening and closing display portion 312 displays “opening”. Optionally, the second resilient member 33 is a compression spring that is stretched during the closing process of the circuit breaker and is reset during the opening process of the circuit breaker.

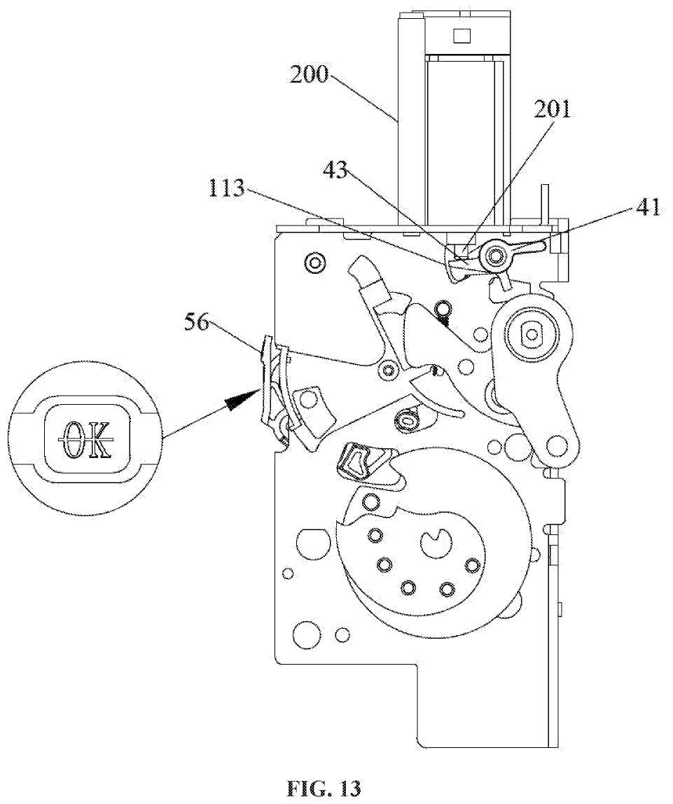

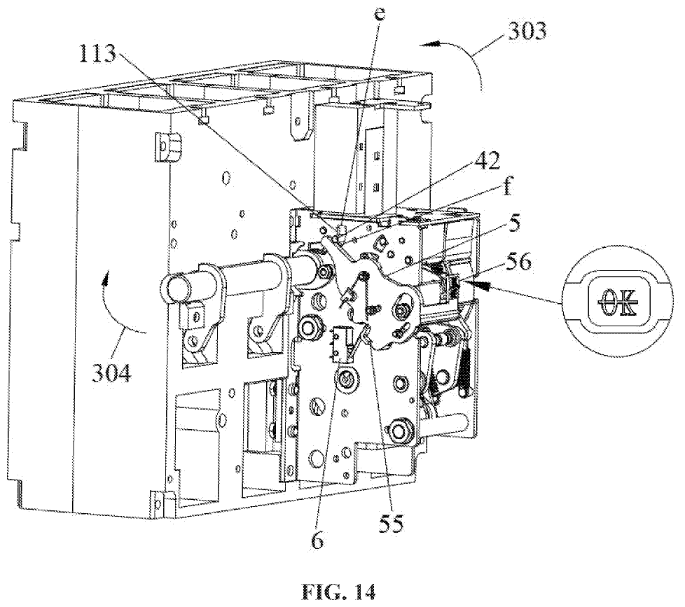

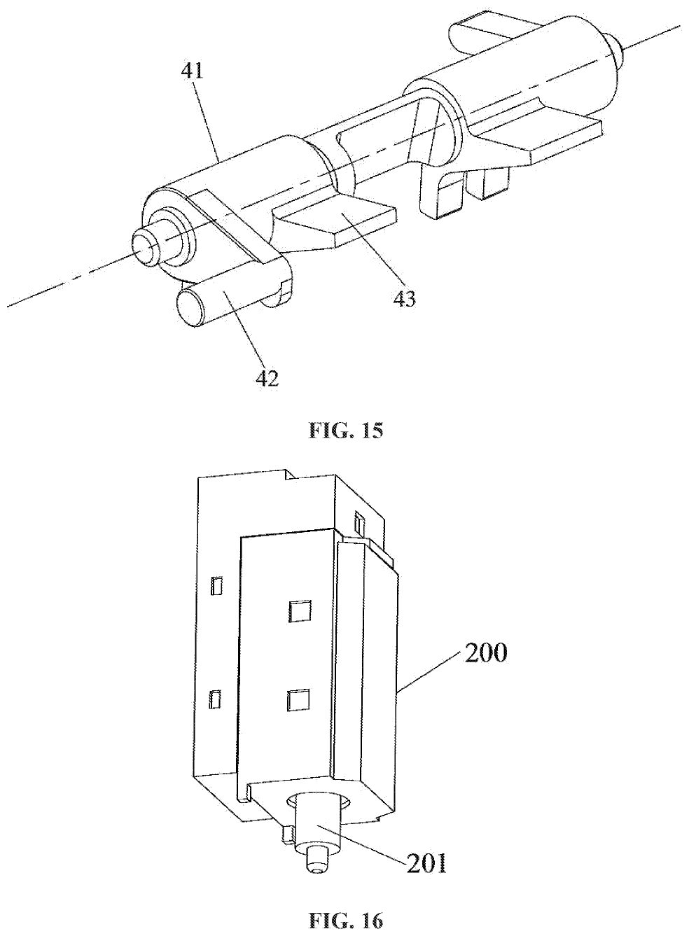

As shown in FIGS. 3 and 13 to 16, the third linkage portion 54 can be linked with the trip transmission unit 4. In some embodiments, the third linkage portion 54 includes a third protruding block disposed at one end of the indicator body 51 away from the fourth linkage portion 55, and the third protruding block is disposed on the outer side of the frame 1. The side plate 11 of the frame 1 is formed with a third slide groove 113. One end of the trip transmission unit 4 passes through the third slide groove 113 and can be linked with the third protruding block. The end of the trip transmission unit 4 linked with the third protruding block can slide along the third slide groove 113 so that the closing readiness indicator 5 can rotate. By disposing the third protruding block on the indicator body 51 to be linked with the trip transmission unit 4, the structure is simple, and the indicator body 51 can be directly connected to the trip transmission unit 4 through the third protruding block so that the state of the closing readiness indicator 5 can be controlled accurately and precisely.

Optionally, the trip transmission unit 4 includes an opening half shaft 41, the opening half shaft 41 is provided with a linkage shaft 42, and the linkage shaft 42 passes through the third slide groove 113.

When the trip transmission unit 4 is in the free state, the linkage shaft 42 is disposed at a first end e of the third slide groove 113. Exemplarily, during the process of switching the trip transmission unit 4 from the non-free state to the free state, the opening half shaft 41 rotates around the third direction 303, and the linkage shaft 42 slides from a second end f of the third slide groove 113 to the first end e of the third slide groove 113 and does not apply pressure to the third protruding block. If the energy storage unit 2 is in the energy storage state, and the opening and closing transmission unit 3 is in the opened state, the closing readiness indicator 5 rotates around the fourth direction 304 to be in the closable display state, and the fourth direction 304 is opposite to the third direction 303. If the energy storage unit 2 is in the energy release state, or the opening and closing transmission unit 3 is in the closed state, the closing readiness indicator 5 does not rotate and is in the non-closable display state.

When the trip transmission unit 4 is in the non-free state, the linkage shaft 42 is disposed at the second end f of the third slide groove 113 and presses against the third protruding block. Exemplarily, during the process of switching the trip transmission unit 4 from the free state to the non-free state, the opening half shaft 41 rotates around the fourth direction 304, the linkage shaft 42 slides from the first end e of the third slide groove 113 to the second end f of the third slide groove 113 and applies the pressure to the third protruding block, and the closing readiness indicator 5 rotates around the third direction 303 to be in the non-openable display state.

The opening half shaft 41 is further provided with an opening cantilever 43. The circuit breaker includes an undervoltage tripper 200. When the undervoltage tripper 200 is in a non-working state due to a power outage or undervoltage, a trip core 201 of the undervoltage tripper 200 extends out and abuts against the opening cantilever 43 and pushes the opening cantilever 43 to rotate around the fourth direction 304, thereby driving the opening half shaft 41 to rotate around the fourth direction 304, the linkage shaft 42 slides from the first end e of the third slide groove 113 to the second end f of the third slide groove 113, and the trip transmission unit 4 is in the non-free state. When the undervoltage tripper 200 is electrified and in a working state, the trip core 201 of the undervoltage tripper 200 retracts, the trip core 201 no longer presses against the opening cantilever 43, the opening half shaft 41 rotates around the third direction 303, the linkage shaft 42 slides from the second end f of the third slide groove 113 to the first end e of the third slide groove 113, and the trip transmission unit 4 is in the free state.

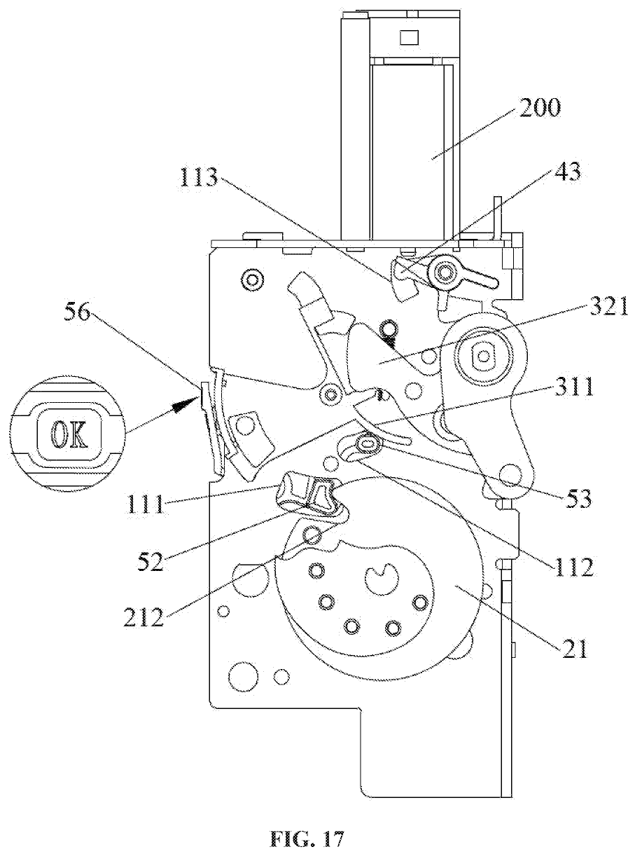

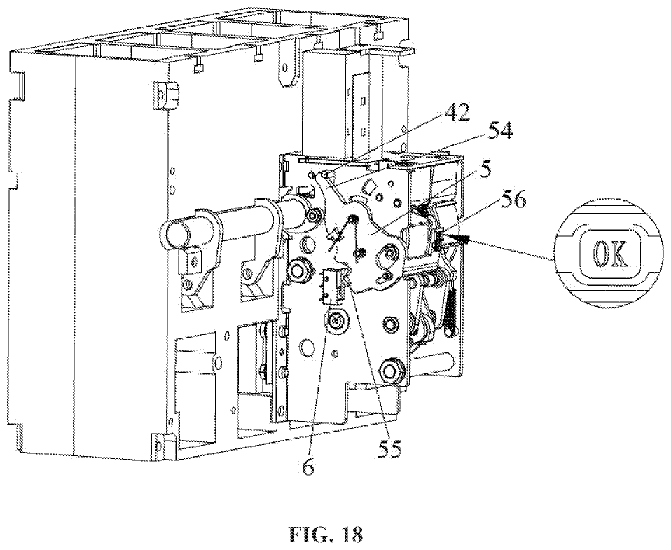

As shown in FIGS. 17 and 18, three conditions need satisfying simultaneously before the circuit breaker is in a closing readiness state. That is, 1. the energy storage unit 2 is in the energy storage state: 2. the opening and closing transmission unit 3 is in the opened state: 3. the trip transmission unit 4 is in the free state. When the preceding three conditions are satisfied simultaneously, the closing readiness indicator 5 is in the closable display state, that is, the closing readiness indication portion 56 of the closing readiness indicator 5 displays “OK”. When any one of the preceding three conditions is not satisfied, the closing readiness indicator 5 is in the non-closable display state, that is, the closing readiness indication portion 56 of the closing readiness indicator 5 displays “OK”.

The closing readiness indicator in the operating mechanism for a circuit breaker provided in the present application is disposed on the outer side of the side plate of the frame to conveniently install and replace the closing readiness indicator, reducing the maintenance cost, and the closing readiness indicator can also be selectively installed so that the circuit breaker can have the function selection performance, satisfying the diversifying requirements of the circuit breaker. Moreover, the first linkage portion of the closing readiness indicator is directly linked with the energy storage unit, the second linkage portion of the closing readiness indicator is directly linked with the opening and closing transmission unit, and the third linkage portion of the closing readiness indicator is directly linked with the trip transmission unit, simplifying the structure connecting the closing readiness indicator to the energy storage unit, the opening and closing transmission unit and the trip transmission unit. In addition, the states of the energy storage unit, the opening and closing transmission unit and the trip transmission unit can keep the closing readiness indicator in the closable display state or the non-closable display state to provide convenience for the operator to accurately determine whether the circuit breaker is in the closable state so that the ineffective closing is avoided.

With continued reference to FIG. 1, this embodiment further provides a circuit breaker including a circuit breaker body 100 and the operating mechanism for the circuit breaker of any one of the preceding solutions. The operating mechanism for the circuit breaker is disposed on the circuit breaker body 100.

The circuit breaker further includes the undervoltage tripper 200. The undervoltage tripper 200 cooperates with the opening cantilever 43 of the preceding opening half shaft 41. The specific cooperation relationship is described in the preceding.

1. An operating mechanism for a circuit breaker, comprising:
a frame;
an energy storage unit, an opening and closing transmission unit and a trip transmission unit, wherein the energy storage unit, the opening and closing transmission unit and the trip transmission unit are disposed within the frame; and
a closing readiness indicator which is rotatably disposed on an outer side of a side plate of the frame and comprises an indicator body, wherein the indicator body is provided with a first linkage portion capable of being linked with the energy storage unit, a second linkage portion capable of being linked with the opening and closing transmission unit and a third linkage portion capable of being linked with the trip transmission unit,
wherein the closing readiness indicator is in a closable display state in a case where the energy storage unit is in an energy storage state, the opening and closing transmission unit is in an opened state, and the trip transmission unit is in a free state; and
wherein the closing readiness indicator is in a non-closable display state in a case where the energy storage unit is in an energy release state, or the opening and closing transmission unit is in a closed state, or the trip transmission unit is in a non-free state.

2. The operating mechanism for the circuit breaker of claim 1,
wherein the indicator body is provided with a fourth linkage portion, and the outer side of the side plate of the frame is provided with a signal generator;
the fourth linkage portion triggers the signal generator in a case where the closing readiness indicator is in the closable display state; and
the fourth linkage portion is unable to trigger the signal generator in a case where the closing readiness indicator is in the non-closable display state.

3. The operating mechanism for the circuit breaker of claim 1,
wherein the indicator body is provided with a closing readiness indication portion;
the closing readiness indication portion displays that a closing is ready in a case where the closing readiness indicator is in the closable display state; and
the closing readiness indication portion displays that the closing is not ready in a case where the closing readiness indicator is in the non-closable display state.

4. The operating mechanism for the circuit breaker of claim 1, wherein the first linkage portion comprises a first protruding block protruding from a side surface of the indicator body facing the side plate, and the side plate of the frame is formed with a first slide groove, wherein the first protruding block passes through the first slide groove and is linked with the energy storage unit, and the first protruding block is slidable along the first slide groove.

5. The operating mechanism for the circuit breaker of claim 4,
wherein the energy storage unit comprises a first cam sheet rotatably connected to the frame and provided with a circumferential portion and a groove portion; and
in a case where the energy storage unit is in the energy storage state, the first protruding block is located at a first end of the first slide groove (111) and disposed opposite to the groove portion, or the first protruding block is located at a second end of the first slide groove and disposed within the groove portion;
in a case where the energy storage unit is in the energy release state, the first protruding block is located at the first end of the first slide groove and abuts against the circumferential portion.

6. The operating mechanism for the circuit breaker of claim 1, wherein the second linkage portion comprises a second protruding block protruding from a side surface of the indicator body facing the side plate, and the side plate of the frame is formed with a second slide groove, wherein the second protruding block passes through the second slide groove and is linked with the opening and closing transmission unit, and the second protruding block is slidable along the second slide groove.

7. The operating mechanism for the circuit breaker of claim 6,
wherein the opening and closing transmission unit comprises an opening and closing indicator and a main shaft that are rotatably connected to the frame separately, wherein the opening and closing indicator (31) comprises a first linkage plate and the main shaft is provided with a main shaft cantilever;
in a case where the opening and closing transmission unit is in the closed state, the main shaft cantilever presses against a first side of the first linkage plate, a second side of the first linkage plate presses against the second protruding block, and the second protruding block is disposed at a first end of the second slide groove; and
in a case where the opening and closing transmission unit is in the opened state, the main shaft cantilever is detached from the first side of the first linkage plate, and the second protruding block is disposed at the first end of the second slide groove or a second end of the second slide groove.

8. The operating mechanism for the circuit breaker of claim 2, wherein the third linkage portion comprises a third protruding block disposed at one end of the indicator body away from the fourth linkage portion, the side plate of the frame is formed with a third slide groove, and one end of the trip transmission unit passes through the third slide groove and is linked with the third protruding block, wherein the end of the trip transmission unit linked with the third protruding block is slidable along the third slide groove.

9. The operating mechanism for the circuit breaker of claim 8,
wherein the trip transmission unit comprises an opening half shaft, wherein the opening half shaft is provided with a linkage shaft passing through the third slide groove;
the linkage shaft is disposed at a first end of the third slide groove in a case where the trip transmission unit is in the free state; and
the linkage shaft is disposed at a second end of the third slide groove and presses against the third protruding block in a case where the trip transmission unit is in the non-free state.

10. The operating mechanism for the circuit breaker of claim 1, wherein the closing readiness indicator further comprises a first resilient member, wherein the first resilient member is connected to the indicator body and the frame, the first resilient member is configured to keep the closing readiness indicator in the closable display state in the case where the energy storage unit is in the energy storage state, the opening and closing transmission unit is in the opened state, and the trip transmission unit is in the free state.

11. A circuit breaker, comprising a circuit breaker body and an operating mechanism for the circuit breaker wherein the operating mechanism for the circuit breaker is disposed on the circuit breaker body and the operating mechanism for the circuit breaker comprises:
a frame;
an energy storage unit, an opening and closing transmission unit and a trip transmission unit, wherein the energy storage unit, the opening and closing transmission unit and the trip transmission unit are disposed within the frame; and
a closing readiness indicator which is rotatably disposed on an outer side of a side plate of the frame and comprises an indicator body, wherein the indicator body is provided with a first linkage portion capable of being linked with the energy storage unit, a second linkage portion capable of being linked with the opening and closing transmission unit and a third linkage portion capable of being linked with the trip transmission unit.
wherein the closing readiness indicator is in a closable display state in a case where the energy storage unit is in an energy storage state, the opening and closing transmission unit is in an opened state, and the trip transmission unit is in a free state; and
wherein the closing readiness indicator is in a non-closable display state in a case where the energy storage unit is in an energy release state, or the opening and closing transmission unit is in a closed state, or the trip transmission unit is in a non-free state.

12. The circuit breaker of claim 11, wherein the indicator body is provided with a fourth linkage portion, and the outer side of the side plate of the frame is provided with a signal generator;
the fourth linkage portion triggers the signal generator in a case where the closing readiness indicator is in the closable display state; and
the fourth linkage portion is unable to trigger the signal generator in a case where the closing readiness indicator is in the non-closable display state.

13. The circuit breaker of claim 11, wherein the indicator body is provided with a closing readiness indication portion;
the closing readiness indication portion displays that a closing is ready in a case where the closing readiness indicator is in the closable display state; and
the closing readiness indication portion displays that the closing is not ready in a case where the closing readiness indicator is in the non-closable display state.

14. The circuit breaker of claim 11, wherein the first linkage portion comprises a first protruding block protruding from a side surface of the indicator body facing the side plate, and the side plate of the frame is formed with a first slide groove, wherein the first protruding block passes through the first slide groove and is linked with the energy storage unit, and the first protruding block is slidable along the first slide groove.

15. The circuit breaker of claim 14, wherein the energy storage unit comprises a first cam sheet rotatably connected to the frame and provided with a circumferential portion and a groove portion; and
in a case where the energy storage unit is in the energy storage state, the first protruding block is located at a first end of the first slide groove and disposed opposite to the groove portion, or the first protruding block is located at a second end of the first slide groove and disposed within the groove portion;
in a case where the energy storage unit is in the energy release state, the first protruding block is located at the first end of the first slide groove and abuts against the circumferential portion.

16. The circuit breaker of claim 11, wherein the second linkage portion comprises a second protruding block protruding from a side surface of the indicator body facing the side plate, and the side plate of the frame is formed with a second slide groove, wherein the second protruding block passes through the second slide groove and is linked with the opening and closing transmission unit, and the second protruding block is slidable along the second slide groove.

17. The circuit breaker of claim 16, wherein the opening and closing transmission unit comprises an opening and closing indicator and a main shaft that are rotatably connected to the frame separately, wherein the opening and closing indicator comprises a first linkage plate, and the main shaft is provided with a main shaft cantilever;
in a case where the opening and closing transmission unit is in the closed state, the main shaft cantilever presses against a first side of the first linkage plate, a second side of the first linkage plate presses against the second protruding block, and the second protruding block is disposed at a first end of the second slide groove; and
in a case where the opening and closing transmission unit is in the opened state, the main shaft cantilever is detached from the first side of the first linkage plate, and the second protruding block is disposed at the first end of the second slide groove or a second end of the second slide groove.

18. The circuit breaker of claim 12, wherein the third linkage portion comprises a third protruding block disposed at one end of the indicator body away from the fourth linkage portion, the side plate of the frame is formed with a third slide groove, and one end of the trip transmission unit passes through the third slide groove and is linked with the third protruding block, wherein the end of the trip transmission unit linked with the third protruding block is slidable along the third slide groove.

19. The circuit breaker of claim 18, wherein the trip transmission unit comprises an opening half shaft, wherein the opening half shaft is provided with a linkage shaft passing through the third slide groove;
the linkage shaft is disposed at a first end of the third slide groove in a case where the trip transmission unit is in the free state; and
the linkage shaft is disposed at a second end of the third slide groove and presses against the third protruding block in a case where the trip transmission unit is in the non-free state.

20. The circuit breaker of claim 11, wherein the closing readiness indicator further comprises a first resilient member, wherein the first resilient member is connected to the indicator body and the frame, the first resilient member is configured to keep the closing readiness indicator in the closable display state in the case where the energy storage unit is in the energy storage state, the opening and closing transmission unit is in the opened state, and the trip transmission unit is in the free state.
